(19) United States
(12) Patent Application Publication
(10) Pub. No.: US 2024/0256399 A1
(43) Pub. Date: Aug. 1, 2024

(54) DATABASE RECOVERY USING A CLOUD-BASED STORAGE SYSTEM

(71) Applicant: Salesforce, Inc., San Francisco, CA (US)

(72) Inventors: Steven Raspudic, Walnut Creek, CA (US); Goutham Meruva, Danville, CA (US); Heetae Kim, Seattle, WA (US); Hefeng Yuan, Sammamish, WA (US); Praveenkumar Bagavathiraj, San Jose, CA (US)

(21) Appl. No.: 18/162,525

(22) Filed: Jan. 31, 2023

(51) Int. Cl. G06F 11/14; G06F 16/11; G06F 16/182

(52) U.S. Cl. CPC G06F 11/1469; G06F 16/113; G06F 16/1844; G06F 2201/84

(57) ABSTRACT

In various embodiments, an archival agent of a database tracks database records stored in a primary storage of a cloud-based storage system to identify particular database records that are relevant to a current state of the database. A replication service of the cloud-based storage system replicates database records from the primary storage to an archival storage that includes database records of the database that are no longer relevant to the current state of database. The archival agent records identifiers of the particular relevant database records in a manifest file associated with the current state of the database and provides the manifest file to the replication service for storage in the archival storage. In response to a failure associated with the primary storage, the database can be recovered to its current state using the identifiers recorded in the stored manifest file to determine what database records to read.

### BACKGROUND

### Technical Field

This disclosure relates generally to data storage, and, more specifically, to increasing database reliability through database archiving and recovery.

### Description of the Related Art

Enterprises have traditionally operated on-premises equipment to implement computer infrastructure. This, however, can be an expensive proposition as computing equipment can be costly and inevitably requires replacement. Computing equipment may also be underutilized as an infrastructure is often designed to support worst-case and worst-case scenarios. For these reasons, cloud computing has become an appealing option as an enterprise can use computing resources supplied by a cloud service provider, which is separately responsible for maintaining and upgrading computing equipment. These computing resources can be obtained at a cost competitive price point as resources may be more efficiently utilized since they are shared among multiple users/tenants—and can be dynamically scalable based on an enterprise's needs. Popular services offered by cloud service providers can include application hosting in which an application executes on a computer cluster implemented by servers housed in one or more server farms of the cloud service provider. Other popular services can include data storage in which a computer cluster with access to large storage arrays is used to store data.

### BRIEF DESCRIPTION OF THE DRAWINGS

FIG. 1 is a block diagram illustrating one embodiment of a computing system configured to implement database archival and recovery using a cloud-based storage system.

FIG. 2 is a block diagram illustrating one embodiment of a manifest creation performed by an archival agent of the computing system to facilitate archival and recovery.

FIG. 3 is a diagram illustrating one embodiment of a manifest validation performed by the archival agent.

FIG. 4 is a diagram illustrating one embodiment of a database recovery performed by the archival agent.

FIGS. 5A and 5B are block diagrams illustrating embodiments of a garbage collection associated with the cloud-based storage system.

FIGS. 6A-6C are flow diagrams illustrating embodiments of methods for database archival and recovery.

FIG. 7 is a block diagram illustrating one embodiment of an exemplary multi-tenant system for implementing various systems described herein.

### DETAILED DESCRIPTION

A database operator may want to backup/archive database records to a separate archival storage in order to potentially recover database state. For example, an operator of a multi-tenant database may offer to preserve tenant data for some defined period (e.g., 90 days) even after that data is no longer in use, so a particular tenant can recover it if desired. Cloud service providers may offer various forms of archival storage for preserving data such as Amazon Web Services (AWS)® Simple Storage Service (S3)™. To make it easier for a user to transfer data to an archival storage, cloud service providers may offer a replication service (for free or a low cost) that can periodically copy content to an archival storage from some other source.

While helpful, these replication services cannot be solely relied on for database backup and recovery. First, replication services are generally agnostic to the data being replicated. Accordingly, a replication service may have no understanding that it is processing records of some higher-level database, much less that a first set of replicated database records corresponds to a current state of the database at one point in time and a second set of replicated database records corresponds to a current state of the database at another later point in time-making it difficult to know what records to retrieve from archival storage to recover to the later time. Second, replication services can behave somewhat sporadically in that a given service might copy data at any point within a fifteen-minute window, for example, and further replicate data objects in any order. Thus, if database records were initially written to a source in database transaction order, this order cannot be relied on for recovery as 1) the ordering that database records are received at an archival storage may differ from the order written to the source and 2) holes in the order may exist as some records still await replication.

The present disclosure describes embodiments in which an archival agent works in conjunction with a cloud service provider's replication service to facilitate database archival and recovery. As will be described below, a database writes its database records to a primary storage, which may be hosted by a cloud service provider. A replication service of the cloud service provider may then copy these records to an archival storage of the provider. As database transactions are processed over time, these records may contain data that is no longer relevant to the current state of the database as later database transactions update data recorded by earlier transactions. In various embodiments, the archival agent tracks database records to identify ones that are relevant to a current state of the database. The archival agent then identifies these database records in a manifest that it periodically provides to the replication service for storage in the archival storage. If a database recovery is subsequently warranted (e.g., due to a corruption of the primary storage), the archival storage can be accessed to obtain a previously stored manifest (e.g., associated with a database state prior to the corruption), which can be used to determine the set of relevant records. These records can then be retrieved from the archival storage to rebuild the database to a prior valid state.

In many instances, using manifests in this manner can allow a database system to use existing replication services in spite of the issues noted above. Furthermore, because some cloud service providers charge fees only when data is moved out of (or into) storage, using manifests can reduce incurred fees as only database records identified in a given manifest may need to be retrieved to recover the database to a particular state (as opposed to reading large numbers of database records to determine, after the fact, which ones are relevant to the particular state).

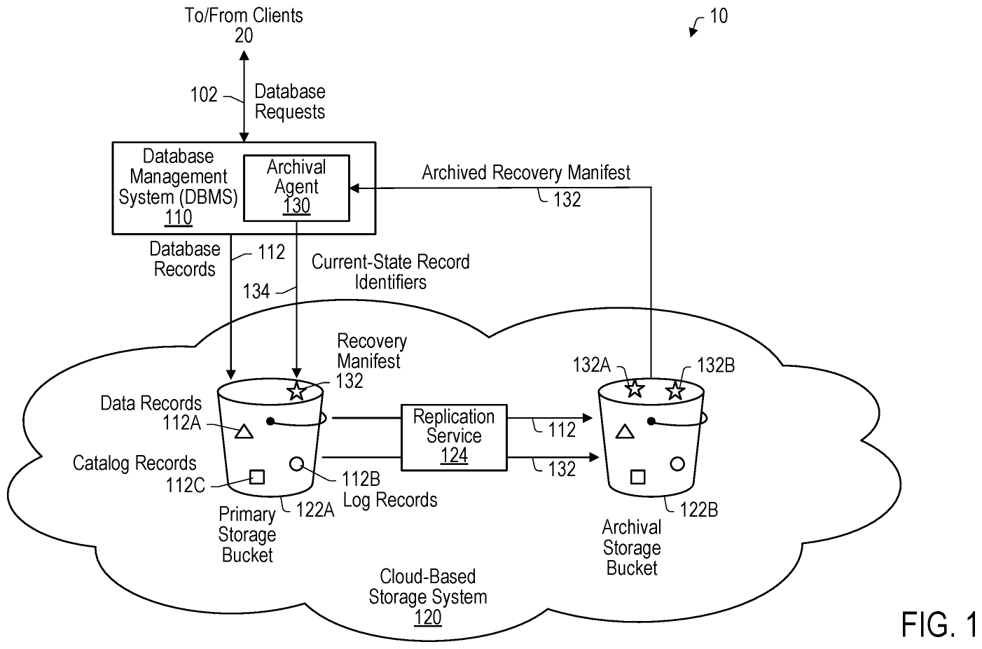

Turning now to FIG. 1, a block diagram of a computing system 10 configured to implement database archival and recovery using a cloud-based storage is depicted. As shown, system 10 may include database management system (DBMS) 110 and cloud-based storage system 120. In the illustrated embodiment, DBMS 110 includes archival agent 130. Cloud-based storage system 120 includes a primary storage bucket 122A, an archival storage bucket 122B, and a replication service 124. In some embodiments, system 10 may be implemented differently than shown. For example, archival agent 130 may be implemented separately from DBMS 110, functionality described below with respect to archival agent 130 may be implemented by multiple separate components, multiple primary storage buckets 122A and/or archival storage buckets 122B may be used, etc.

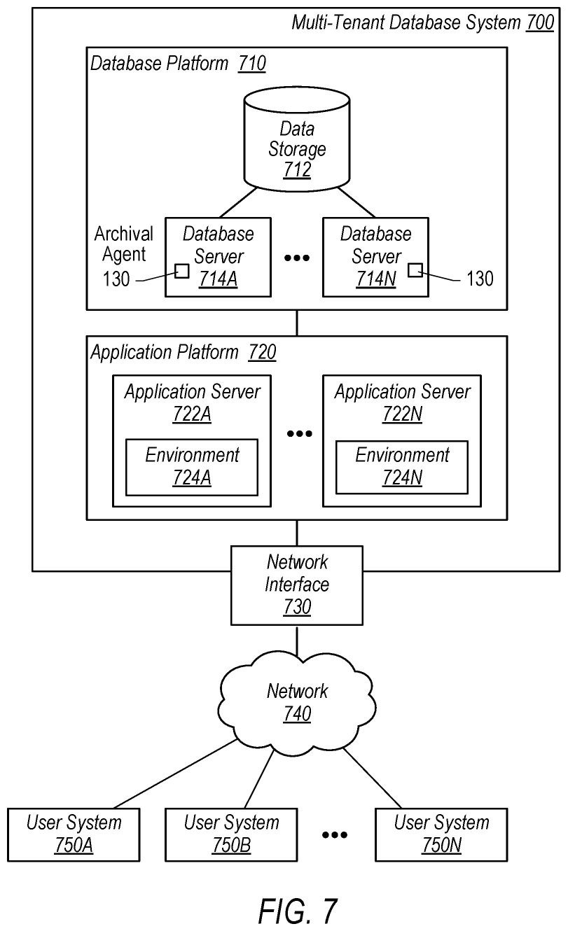

DBMS 110 is a set of program instructions executable to implement a database. As shown, DBMS 110 may process database requests 102 received from clients 20, which may correspond to any suitable sources such client devices, application servers, software or hardware located elsewhere in computing system 10, etc. such as discussed below with FIG. 7. Based on database requests 102, DBMS 110 may read and write corresponding database records 112. DBMS 110 may support any suitable type of database such as a relational database, key-value store, block store, object store, etc. DBMS 110 may also support database transactions with atomicity, consistency, isolation, and durability (ACID) properties. To implement the database, DBMS 110 may maintain schema metadata defining a catalog that identifies the structure of the database. DBMS 110 may also maintain a transaction log identifying a history of changes made to the database over time by database transactions associated with database requests 102. As database transactions are processed, DBMS 110 may record their information in the transaction log including their corresponding keys and data. In the illustrated embodiment, DBMS 110 stores data supplied by database requests 102 in data records 112A, transaction log metadata in log records 112B, and schema metadata in catalog records 112C; in other embodiments, data and metadata may be organized differently.

In various embodiments, DBMS 110 implements a copy-on-write storage scheme in which database records 112 are immutable upon creation. That is, if a new database transaction attempts to update a data value present in an existing database record 112, the data value is not updated within the record 112; rather, contents of the database record 112 are copied into a new record 112 with the updated data value. As a result, multiple versions of a given database record 112 may be created over time, but only one may pertain to the current state of the database at a given point in time-a point that can complicate database recovery and warrant use of garbage collection as will be discussed. To organize multiple database records 112 generated over time in a manner that can improve access latencies, in some embodiments, DBMS 110 may further insert records 112 into a log-structured merge (LSM) tree for persistent storage. In such an embodiment, levels of the LSM tree may be distributed across multiple storages having different access latencies with higher levels being smaller but offering shorter latencies in contrast to lower levels being larger but offering longer latencies. These storages may be distributed among multiple physical computer systems providing persistent storage (or, in some embodiments, multiple types of storage buckets 122 as will be discussed). In some embodiments, DBMS 110 implements a multi-tenant database that hosts a significant volume of data belonging to multiple users/tenants, which may be part of a software as a service (SaaS) model. As a result, DBMS 110 may benefit from storing database records 112 in one or more storages provided by a cloud-based storage system 120.

Cloud-based storage system 120 is a distributed computer cluster operated by a cloud service provider to provide data storage services. As shown, cloud-based storage system 120 may provide data storage via storage buckets 122—containers that serve to organize a given tenant's data and isolate the data from data belonging to other tenants in other containers. To facilitate data organization, in some embodiments, storage buckets 122 implement object storages that accept key-value pairs, which can each include a variable-sized value/object and its corresponding key used to facilitate its storage and retrieval. These storages may also be referred to as key-value storages or non-relational storages. In other embodiments, however, buckets 122 may implement other types of storages such as block storages or relational storages. In various embodiments, cloud-based storage system 120 may also offer buckets 122 that afford different levels of quality of service (QOS) based on a given tenant's access criteria. For example, cloud-based storage system 120 may offer a first type of bucket 122 that has lower access latencies but cost more and a second type of bucket 122 that costs less but has higher access latencies.

Primary storage bucket 122A is used as a primary/production storage for database records 112 produced by DBMS 110. To quickly service database requests 102, primary storage bucket 122A may be implemented using a type of bucket 122 that offers low latency reads and writes such as Amazon S3's standard bucket type. In embodiments in which an LSM tree is used, one or more levels of the tree may be stored in primary storage bucket 122A. In some embodiments, DBMS 110 may also use a separate data cache for database records 112 to improve access times. Although a single primary storage bucket 122A is depicted in FIG. 1, system 10 may, in other embodiments, use multiple primary storage buckets 122A, which may further be implemented using different bucket types. For example, in some embodiments, different LSM levels may be implemented using buckets 122A providing different levels of QoS. In some embodiments in which DBMS 110 implements a multi-tenant database, different types of buckets 122A may be used to provide tenants with different QoS levels based on tenant criteria.

Archival storage bucket 122B is used an archival storage for database records 112. Because archival storage bucket 122B is likely to be accessed less frequently than primary storage bucket 122A, archival storage bucket 122B may be implemented using a type of bucket 122 that offers higher latency reads and writes but at a cheaper cost than bucket 122A's type such as Amazon S3's Glacier bucket type. In some embodiments, archival storage bucket 122B is located in a different geographic region from primary storage bucket 122A (i.e., stored on cluster servers located in a different server farm) to ensure that a problem at given site does not affect both buckets 122A and 122B. As with primary storage bucket 122A, system 10 may use multiple archival storage buckets 122, which may have different types to afford different levels of QoS for tenants using the database (or may be similar types in other embodiments). To make it easier to store data in an archival storage bucket 122B, cloud-based storage system 120 may provide replication service 124.

Replication service 124 is a service that copies/replicates data from one bucket to another such as from primary storage bucket 122A to archival storage bucket 122B. To reduce the amount of data being transmitted between buckets 122A and 122B, replication service 124 may implement deduplication for data records 112, so that it is not continually replicating the same record 112 over time. In various embodiments, replication service 124 operates independently of DBMS 110—thus, it may replicate database records 112 asynchronously and in a different order than DBMS 110 wrote records 112 to primary storage 122A. As such, replication service 124 may suffer from the same issues noted in the introduction above and thus may be unsuitable by itself for facilitating archival and recovery of the database implemented by DBMS 110. In the illustrated embodiment, however, DBMS 110 may turn to archival agent 130, which can be used in conjunction with replication service 124 to implement archival and recovery.

Archival agent 130 is a set of program instructions executable to track which database records 112 are relevant to a current state of the databases and identify them in a manifest 132 for subsequently recovering the database to that state. Archival agent 130 may obtain this information using any suitable techniques. In some embodiments, archival agent 130 receives metadata on the relevancies of records 112 from other components of DBMS 110 via an application program interface (API). In some embodiments, relevancy metadata is stored in one or more data structures maintained by DBMS 110 and accessible to archival agent 130. In various embodiments, DBMS 110 writes a tombstone (e.g., sets a particular flag) in a database record 112 to indicate when it no longer pertains to the current state of the database; in some embodiments, archival agent 130 scans primary storage bucket 122A to read these tombstones from stored records 112.

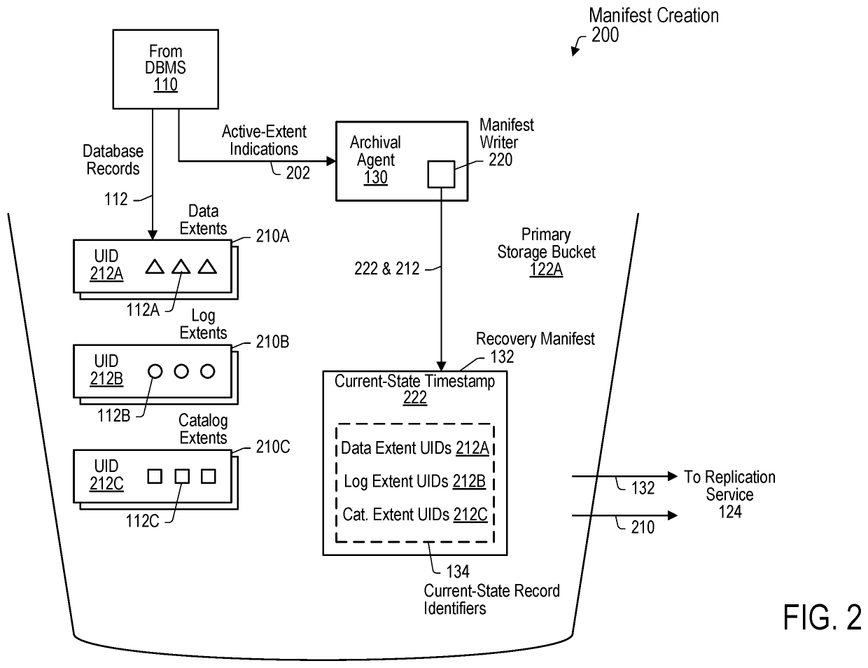

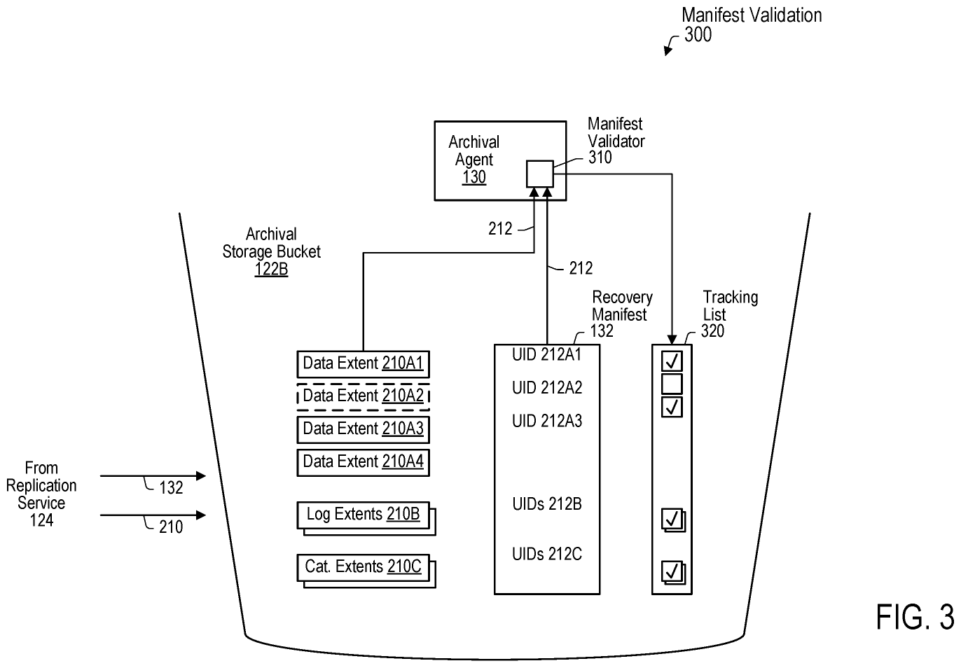

A recovery manifest 132 is a file that includes current-state record identifiers 134 that identify database records 112 relevant to a current state of the database at the time of manifest 132's creation. In some embodiments, record identifiers 134 in manifest 132 uniquely identify particular records 112. For example, identifiers 134 may be the keys for storing and retrieving records 112 from buckets 122A and/or 122B. In other embodiments, identifiers 134 uniquely identify containers (referred to as extents in the discussion of FIG. 2 further below) that each include multiple database records 112. In some embodiments, archive agent 130 uses a single manifest 132 to record identifies 134 for the entire/complete set of relevant database records 112 for a given current state of the database. In other embodiments, archive agent 130 may use multiple manifests 132 to capture a given current state such as in embodiments when multiple primary storage buckets 122A are used. Once a manifest 132 has been created, archival agent 130 may provide the manifest 132 to replication service 124 for storage in archival storage bucket 122B. In the illustrated embodiment, archival agent 130 provides a manifest 132 to replication service 124 by writing manifest 132 to primary storage bucket 122A in order to cause replication service 124 to replicate it to archival storage bucket 122B. In other embodiments, manifests 132 may be provided differently. Once a manifest 132 has been replicated to the bucket storage 122B, archive agent 130 may perform a validation of the manifest 132 to confirm that it can be used to facilitate a database recovery-which may include verifying that all the relevant database records 112 have also been successfully replicated as will be discussed with FIG. 3.

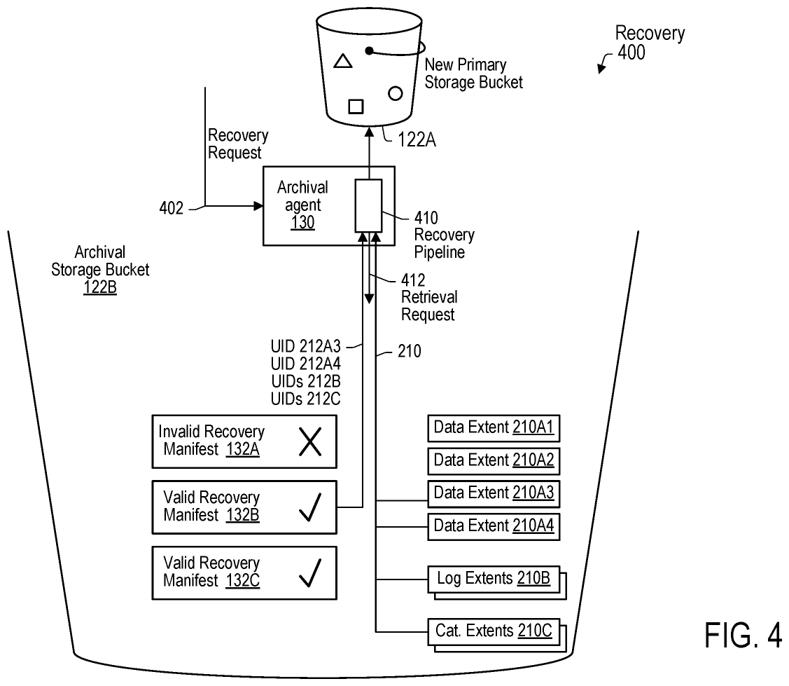

If a database recovery to a particular prior state is subsequently desired, in various embodiments, archive agent 130 can select an archived recovery manifest 123 associated with that state in order to determine, based on record identifiers 134, what records 112 are relevant to that state. Archive agent 130 can then retrieve only those relevant records 112. As archival storage bucket 122B may include large numbers of records 112 belonging to multiple states of the database that have been archived over time, retrieving just the relevant records 112 can offer considerable savings over reading large portions of bucket 122B if, in some embodiments, cloud-based storage system 120 charges fees based on the number of accesses to bucket 122B. As relevant records 112 are retrieved, archival agent 130 may then use them to rebuild database including its various structures, which may be provisioned in a new primary storage bucket 122A requested from cloud-based storage system 120 as will be discussed below in more detail with FIG. 4.

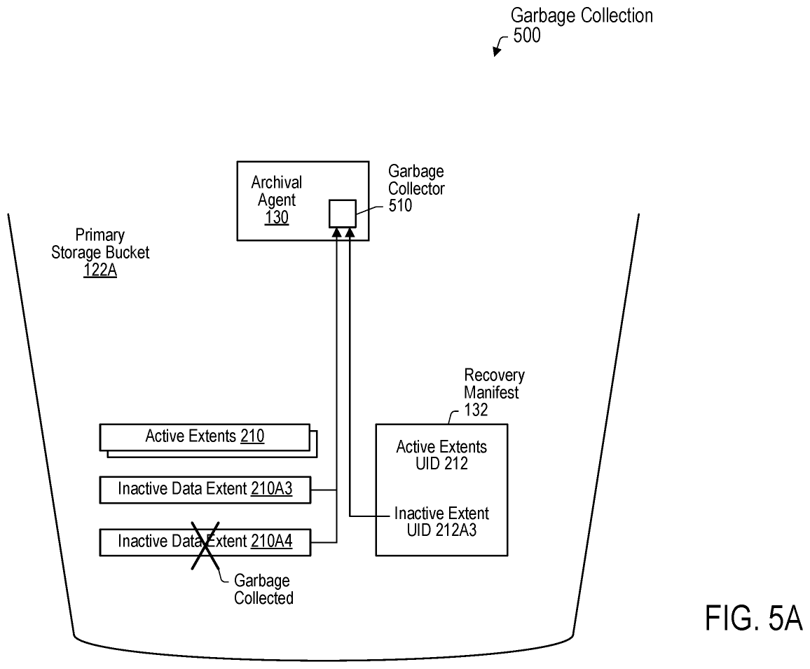

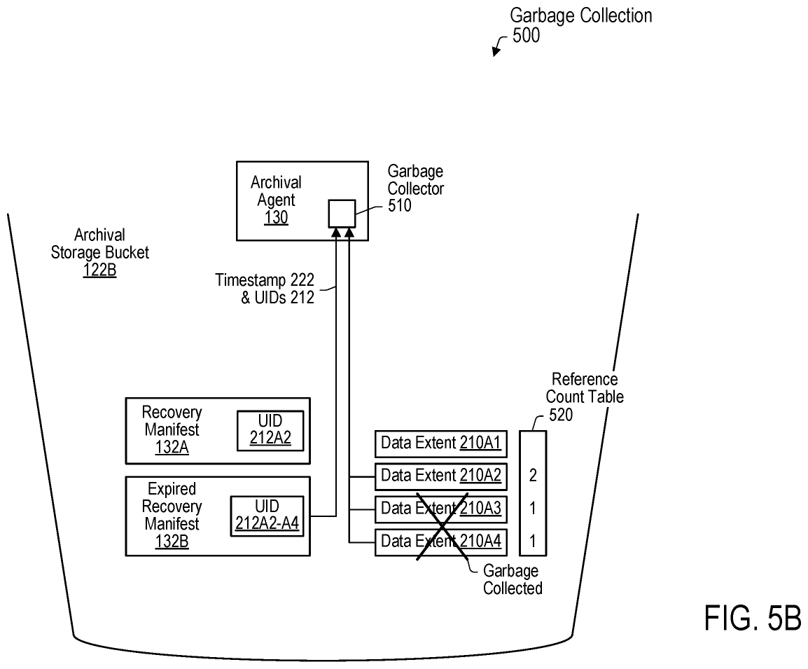

In some embodiments, recovery manifests 132 may have uses beyond merely database recovery. As records 112 accumulate over time in primary storage bucket 122A and archival storage bucket 122B, manifests 132 may be used in garbage collection of records 112 to reclaim storage space occupied by records 112 that no longer warrant preservation as will be discussed with FIGS. 5A and 5B.

The contents of a manifest 132 and its creation will now be discussed in more detail with respect to FIGS. 2 and 3.

Turning now to FIG. 2, a block diagram of a manifest creation 200 is depicted. As shown, primary storage bucket 122A may include a recovery manifest 132 and extents 210, which may include database records 112 and UIDs 212. Archival agent 130 may include manifest writer 220. In some embodiments, manifest creation 200 may be implemented differently than shown—e.g., DBMS 110 may not use extents 210 to store database records 112.

Extents 210 are files/containers that include multiple database records 112. As database records 112 are created, DBMS 110 may insert them into a given extent 210 until that extent 210 fills and DBMS 110 opens a new extent 210. As shown, different types of database records 112 may be grouped into different types of extents 210 such as data extents 210A including data records 112A, log extents 210B including log records 112B, and catalog extents 210C including catalog records 112C. Each extent 210 may also be associated with a respective unique identifier (UID) 212 that unique identifies that extent 210 from other extents 210. In some embodiments, UIDs 212 are unique keys that are usable to access extents 210 in buckets 122. In some instances, usage of extents 210 may make it easier to manage large numbers of database records 112 with respect to storage buckets 122.

Manifest writer 220 is a set of program instructions executable to perform manifest creation 200. In the illustrated embodiment, manifest writer 220 receives active extent indications 202, which indicate which data extents 210 include database records 112 relevant to the current state of the database. In some embodiments, active extent indications 202 may be obtained from other components in DBMS 110, other data structures maintained by DBMS 110, or determined from metadata recorded in extents 210 as discussed above with FIG. 1. As manifest writer 220 receives indications 202, it may write corresponding UIDs 212 of active extents 210 (i.e., those holding records 112 relevant to the current state of the database) to recovery manifest 132. As shown, recovery manifest 132 may include data extent UIDs 212A corresponding to data extents 210A, log extents UIDs 212B corresponding to log extents 210B, and catalog extents UIDs 212C corresponding to catalog extents 210C. Manifest writer 220 may also record a current-state timestamp 222 to recovery manifest 132 to indicate the time associated with the current state of the database. Manifest writer 220 may create a manifest 132 in response to any of suitable conditions. For example, in some embodiments, manifest writer 220 creates a manifest 132 at a predetermined interval, which may be defined by a database administrator. In other embodiments, manifest writer 220 creates a manifest 132 each time a log extent 210B becomes filed with log records 112B and is closed. In still another embodiment in which extents 210 are maintained in an LSM tree, manifest writer 220 may write a recovery manifest 132 each time DBMS 110 merges two extents 210 into a single extent 210 that is placed at a lower level in the LSM tree.

As extents 210 and manifests 132 are stored in primary storage bucket 122A, replication service 124 may read them and write corresponding copies to archival storage bucket 122B. As will be discussed next, prior to permitting a recovery using a manifest 132, archival agent 130 may perform a validation of the archived manifest 132.

Turning now to FIG. 3, a block diagram of a manifest validation 300 is depicted. In the illustrated embodiment, archival agent 130 includes a manifest validator 310. Archival storage bucket 122B may also include multiple extents 210, a recovery manifest 123, and a tracking list 320. In some embodiments, manifest validation 300 may be implemented differently than shown—e.g., manifest validator 310 may be separate from archival agent 130.

Manifest validator 310 is a set of program instructions executable to perform manifest validations 300 for manifests 132 archived in archival storage bucket 122B. In various embodiments, a given validation 300 includes determining whether replication service 124 has successfully replicated the relevant database records 112 (or more specifically the extents 210 that include them in some embodiments) to archival storage bucket 122B. In the illustrated embodiment, manifest validator 310 makes this determination using a tracking list 320 for each manifest 132, which can include a respective entry for each UID 212 in a given recovery manifest 132. For example, in FIG. 3, tracking list 320 includes entries for UIDs 212A1-3 corresponding data extents 210A1-3—along with UIDs 212B and 212C for log extents 210B and catalog extents 212C. As extents 210 are replicated by replication service 124, indications may be recorded in tracking list 320. Accordingly, in FIG. 3, replication service 124 has replicated data extents 210A1, 210A3, and 210A4 but has yet to replicate data extent 210A2, which has a corresponding UID 212A2 present in recovery manifest 132. Thus, tracking list 320 does not include a corresponding indication yet for UID 212A2, which can be set when data extent 210A2 is later replicated. Once manifest validator 310 can confirm that all relevant extents 210 have been received for a given manifest 132, manifest validator 310 may store an indication in archival storage bucket 122B to indicate the manifest 132 is valid and ready for use in a recovery.

Turning now to FIG. 4, a block diagram of a database recovery 400 is depicted. In the illustrated embodiment, archival agent 130 includes a recovery pipeline 410. Archival storage bucket 122B includes invalid and valid recovery manifest 132 and data extents 210. In some embodiments, recovery 400 may be implemented differently than shown—e.g., recovery pipeline 410 may be implemented separately from archival agent 130.

Recovery pipeline 410 is a set of program instructions executable to perform a recovery 400 of a previous archived database state. In the illustrated embodiment, recovery pipeline 410 may initiate a recovery 400 in response to a recovery request 402. This recovery request 402 may come from any suitable source such as an administrator submitting request 402 via a graphical user interface (GUI), automation software designed to detect a failure associated with the database, etc. In some embodiments, recovery request 402 may include an indication of the particular desired state to be used for recovery. For example, recovery request 402 may include a timestamp 222 of a prior archived state of the database. Alternatively, request 402 may specify that the most recently archived state should be used.

In response to receiving a recovery request 402, recovery pipeline 410 may select an appropriate manifest 132 from archival storage bucket 122B. In some embodiments, if request 420 is asking for the most recent valid, pipeline 410 may access a corresponding pointer maintained by manifest validator 310 for a most recently valid manifest 132. In some embodiments, if a timestamp 222 has been specified in request 402, this selection may include pipeline 410 accessing an index to find a manifest 132 having the same timestamp 222 (or the closest timestamp 222) and confirming that the manifest file has been successfully validated. Based on the UIDs 212 included in the selected manifest 132, pipeline 410 may issue a corresponding request 412 to retrieve the set of relevant database records 112 associated with those UIDs 212. For example, in FIG. 4, pipeline 410 may forgo selecting recovery manifest 132A as it has not completed validation and instead select valid recovery manifest 132B, which may correspond to the most recent validated manifest 132. As shown, pipeline 410 may read the UIDs 212A-C out of the manifest 132 and then issue a corresponding retrieval request 412 specifying the UIDs 212.

Based on the set of relevant database records 112 in retrieved extents 210, recovery pipeline 410 may rebuild the database in a primary storage bucket 122A of cloud-based storage system 120. In some embodiments, rebuilding the database may include more than merely copying extents 210 into a primary storage bucket 122A. For example, this rebuilding may include recovery pipeline 410 inserting data records 210A back into a log structured merge (LSM) tree having one or more levels stored in the primary storage bucket 122A. In some embodiments, this rebuilding includes recovery pipeline 410 replaying a transaction log defined in log records 112B of retrieved log extents 210B to recover the database to the prior state. In particular, recovery pipeline 410 may use data records 112A to recover the database to an initial state. As some database transactions may have committed without their corresponding data records 112A being written successfully to primary storage bucket 112A, recovery pipeline 410 may transition the recovered database from the initial state to the current state (or at least a later state) by replaying the transaction log defined in the log records 112B. In some embodiments, this rebuilding includes pipeline 410 rebuilding a database catalog based on a schema defined in catalog records 112C of retrieved catalog extents 210C. In some embodiments, pipeline 410 may request a new primary storage bucket 122A from cloud-based storage system 120, so that it is not trying to rebuild the database on top of an existing primary storage bucket 122A, which might be experiencing some problem. To automate these various actions of recovery 400, in some embodiments, recovery pipeline 410 may be implemented in part using continuous integration (CI) software, such as a Spinnaker pipeline.

As noted above, in various embodiments, database records 112 may be preserved for some finite period due to storage and cost limitations. To reclaim storage space, system 10 may implement the garbage collection techniques described next with FIGS. 5A and 5B.

Turning now to FIG. 5A, a block diagram of a garbage collection 500 associated with primary storage bucket 122A is depicted. As shown, primary storage bucket 122A may include active extents 210 (i.e., extents having database records 112 relevant to the current state of the database), inactive data extents 210 (i.e., extents that have database records 112 no longer relevant to the current state of the database), and a recovery manifest 132. In the illustrated embodiment, archival agent 130 includes a garbage collector 510 executable to perform garbage collection 500; in other embodiments, garbage collector 510 may be a separate component from archival agent 130.

In various embodiments, archival agent 130 may preserve a local copy of recovery manifest 132 in primary storage bucket 122A until it can be replicated to archival storage bucket 122B and successfully validated in order to ensure that manifest 132 and all its referenced extents 210 have been successfully archived. If a problem with the archival is later encountered, the local copy of manifest 132 can be used to identify what extents 210 still warrant replication in order to enable a future recovery using the manifest 132.

While recovery manifest 132 and its referenced extents 210 are being replicated, garbage collector 510 may initiate garbage collection 500 to reclaim storage space occupied by inactive extents 210 (and their database records 112) in primary storage bucket 122A. In order to ensure that garbage collector 510 does not reclaim storage space of inactive extents 210 awaiting replication to archival storage bucket 122B, in various embodiments, a garbage collector 510 is barred from reclaiming storage space occupied by inactive extents 210 in primary storage bucket 122A if they have UIDs 212 recorded in recovery manifest 132 prior to it being successfully validated. For example, in FIG. 5A, primary storage bucket 122A includes two inactive data extents 210A3 and 210A4. Inactive data extent 210A3 is currently referenced by recovery manifest 132 as its UID 212A3 is included in manifest 132 while inactive data extent 210A4 is not. Thus, garbage collector 510 is permitted to reclaim storage space of inactive data extent 210A4 but not inactive data extent 210A3. In some embodiments, this barring is self-imposed—e.g., garbage collector 510 may read the UIDs 212 in recovery manifest 132 and confirm that the UID 212 of a given inactive extent 210 is not present in manifest 132 before reclaiming storage space of that extent 210. In other embodiments, this barring may be imposed by some other component, such as archival agent 130, which may acquire exclusion locks associated with referenced extents 210 (or referenced database records 112) to prevent them from being garbage collected.

Turning now to FIG. 5B, a block diagram of garbage collection 500 associated with archival storage bucket 122B is depicted. In the illustrated embodiment, archival storage bucket 122B includes a recovery manifest 132A, an expired recovery manifest 132B, multiple data extents 210, and a reference count table 520. In other embodiments, garbage collection 500 may be implemented differently than shown.

As noted above, an operator of computing system 10 may agree to store database records 112 for some particular period (e.g., 90 days) in order to allow their recovery. A challenge, however, is that, in various embodiments, garbage collector 510 cannot merely scan extents 210 in archive bucket 122B to identify those exceeding a particular archival threshold for garbage collection as some extents 210 may be referenced by multiple recovery manifests 132 as their included database records 112 belong to multiple archived states of the database. To account for this, garbage collection 500 may rely on recovery manifests 132.

In particular, garbage collector 510 may implement garbage collection 500 by examining the timestamps 222 of recovery manifests 132 stored in archive bucket 122B to determine if any has been stored in archival storage bucket 122B for an amount of time that satisfies a particular time threshold (e.g., exceeds 90 days). For example, in FIG. 5B, garbage collector may discover that expired recovery manifest 132B meets this age criterion while recovery manifest 132A does not. In some embodiments, garbage collector 510 may maintain an index (not shown) tracking timestamps 222 and their associated manifests 132 to more quickly make this determination. In response to identifying a manifest 132 that does meet this criterion, garbage collector 510 may examine the UIDs 212 included in the manifest 132 to identify potential candidate extents 210 for garbage collection. If garbage collector 510 identifies a UID 212 that is not present in any other manifests 132, garbage collector 510 is permitted to reclaim the storage space occupied by that extent 210. If, however, a UID 212 is included in another manifest 132, than its corresponding extent 210 cannot be garbage collected. Accordingly, in the example depicted in FIG. 5B, expired recovery manifest 132B includes UIDs 212A2-4. Since UIDs 212A3 and 212A4 are not present in any other manifest 132 while UID 212A2 is present in recovery manifest 132A, data extents 210A3 and 210A4 can be garbage collected while data extent 210A2 cannot.

To more quickly determine whether a given UID 212 is referenced by multiple manifests 132, in some embodiments, garbage collector 510 may maintain reference count table 520 when it validates manifests 123 in order to track the number of times that a given extent's UID 212 is referenced by archived manifests 132. For example, in FIG. 5B, data extent 210A2 has a count of two since its UID 212A2 appears in both recovery manifests 132A and 132B; data extents 210A3 and 210A4 have a count of one since their UIDs 212 only appear in manifest 132B. When a new recovery manifest 132 gets stored in archive storage bucket 122B, its referenced extents 210 may have their counts incremented. When a recovery manifest 123 is later garbage collected, its referenced extents 210 may have their counts decremented. Accordingly, if garbage collector 510 determines, from table 520, that a candidate UID 212 has a count of one, collector 510 may then determine to reclaim the storage space occupied by the corresponding extent 210. If collector 510 instead sees a count of two, collector 510 may delay collection of that extent 210 for another iteration of garbage collection 500 and continue examining other UIDs 212.

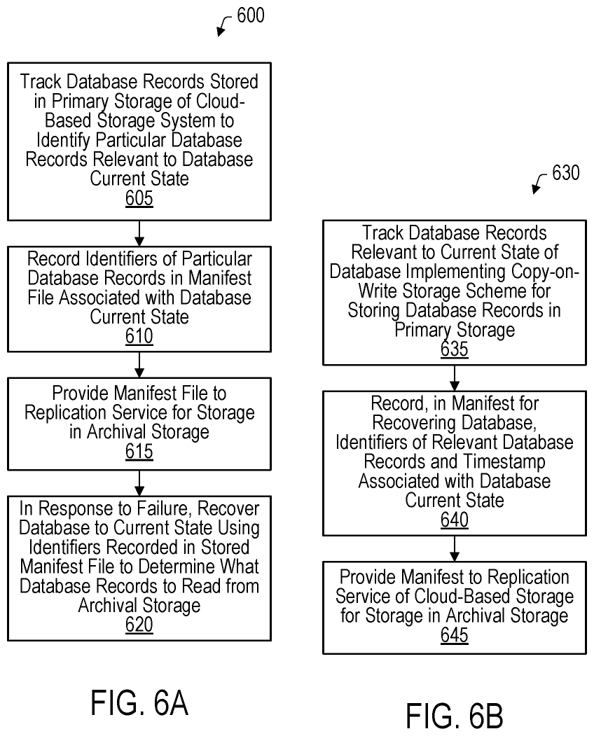

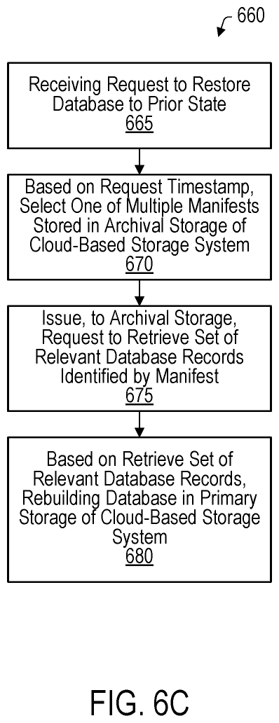

Turning now to FIG. 6A, a flowchart of a method 600 for database archival and recovery is depicted. Method 600 is one embodiment of a method performed by a computing system, such as computing system 10, which may be executing archival agent 130. In some instances, performance of method 600 may allow for an efficient way to archive and recover a database using a cloud-based storage system.

In step 605, the computing system tracks database records (e.g., database records 112) stored in a primary storage (e.g., primary storage bucket 122A) of a cloud-based storage system (e.g., cloud-based storage system) to identify particular ones of the database records that are relevant to a current state of the database. In various embodiments, a replication service (e.g., replication service 124) of the cloud-based storage system is operable to replicate database records from the primary storage to an archival storage (e.g., archival storage bucket 122A) that includes database records of the database that are no longer relevant to the current state of database.

In step 610, the computing system records identifiers (e.g., current-state record identifiers 134) of the particular relevant database records in a manifest file (e.g., recovery manifest 132) associated with the current state of the database. In some embodiments, the recorded identifiers are unique identifiers (e.g., UIDs 212) of files (e.g., extents 210) that includes sets of multiple database records. In some embodiments, the primary storage and the archival storage are object storages; the recorded identifiers are keys for retrieving the particular relevant database records from the primary storage and the archival storage.

In step 615, the computing system provides the manifest file to the replication service for storage in the archival storage. In various embodiments, step 615 includes writing the manifest file to the primary storage to cause the replication service to replicate the manifest file to the archival storage.

In step 620, the computing system, in response to a failure associated with the primary storage, recovers the database to the current state using the identifiers recorded in the stored manifest file to determine what database records to read from the archival storage. In various embodiments, prior to the recovering, the computing system performs a validation (e.g., manifest validation 300) of the manifest file stored in the archival storage such that the validation includes reading the recorded identifiers from the manifest file and, based on the read identifiers, verifying (e.g., using tracking list 320) that the replication service successfully replicated the particular relevant database records to the archival storage. In some embodiments, the recovering includes selecting the stored manifest file from among a plurality of manifest files associated with states of the database and confirming that the manifest file has been successfully validated. In some embodiments, step 620 includes reading, from the archival storage, data records (e.g., data records 112A) and log records (e.g., log records 112B) determined based on the identifiers recorded in the stored manifest file, recovering the database to an initial state based on the data records, and transitioning the recovered database from the initial state to the current state by replaying a transaction log defined in the log records.

In some embodiments, method 600 further includes performing a garbage collection (e.g., garbage collection 500) to reclaim storage space in the archival storage, In such an embodiment, the garbage collection includes determining that the archival storage includes a particular manifest file that has been stored for a length of time that exceeds a time threshold, identifying recorded identifiers (e.g., UIDs 212A3 and 212A4 in FIG. 5B) in the particular manifest file that are not present in any other manifest files stored in the archival storage, and reclaiming storage space occupied by database records associated with the identified recorded identifiers.

Turning now to FIG. 6B, a flowchart of a method 630 for archiving database records using an archival storage of a cloud-based storage is depicted. Method 630 is another embodiment of a method performed by a computing system, such as system 10, which may be executing archival agent 130. In some instances, performance of method 630 may enable a computing system to archive database records more efficiently by leveraging existing cloud-provided infrastructure as discussed above.

In step 635, a computing system tracks database records (e.g., database records 112) that are relevant to a current state of a database that implements a copy-on-write storage scheme for storing database records in a primary storage (e.g., primary storage bucket 122A). In some embodiments, the relevant database records include 1) data records (e.g., data records 112A) that include data, 2) log records (e.g., log records 112B) including log metadata of a transaction log, and 3) catalog records (e.g., catalog records 112C) including schema metadata defining a catalog of the database. In some embodiments, the database organizes database records in the primary storage using a log structured merge (LSM) tree.

In step 640, the computing system records, in a manifest (e.g., recovery manifest 132) for recovering the database, identifiers (e.g., current-state record identifiers 134) of the relevant database records and a timestamp (e.g., current-state timestamp 222) associated with the current state of the database. In various embodiments, the primary storage and the archival storage are key-value storages; the recorded identifiers are keys usable to retrieve the relevant database records from the primary storage and the archival storage. In some embodiments, a given one of the keys uniquely identifies a container (e.g., extent 210) that includes multiple ones of the relevant database records.

In step 645, the computing system provides the manifest to a replication service (e.g., replication service 124) of the cloud-based storage for storage in the archival storage. In various embodiments, the replication service replicates database records from the primary storage to the archival storage. In some embodiments, prior to permitting a recovery using the manifest, the computing system determines (e.g., using tracking list 320) whether the replication service has successfully replicated the relevant database records to the archival storage and, based on the determining, stores, in the archival storage, an indication that the manifest is valid. In some embodiments, in response to the manifest being stored in the archival storage for a length of time that satisfies a time threshold (e.g., as indicated by timestamp 222), the computing system determines the recorded identifiers in the manifest and garbage collects the relevant database records (e.g., records 112 in data extents 210A3 and 210A3 in FIG. 5B) identified by the determined identifiers unless the identifiers are included in any other manifests stored in the archive storage (e.g., data extent 210A2 in FIG. 5B).

Turning now to FIG. 6C, a flowchart of a method 660 for database recovery is depicted. Method 660 is another embodiment of a method performed by a computing system, such as system 10, which may be executing archival agent 130. In some instances, performance of method 660 may enable a more efficient recovery of a database using a cloud-based storage system.

In step 665, a computing system receives a request (e.g., recovery request 402) to restore a database to a prior state of the database. In some embodiments, the request identifies a timestamp associated with the prior state.

In step 670, the computing system selects, based on the timestamp, one of a plurality of manifests (e.g., recovery manifests 132) stored in an archival storage (e.g., archival storage bucket 122B) of a cloud-based storage system (e.g., cloud-based storage system 120). In various embodiments, the manifest identifies (e.g., using record identifiers 134 such as UIDs 212) a set of database records (e.g., database records 112 in active extents 210) relevant to a current state of the database when the manifest was created. In various embodiments, the selecting includes determining that the manifest has been identified as valid based on a previous validation of the manifest.

In step 675, the computing system issues, to the archival storage, a request (e.g., retrieval request 412) to retrieve the set of relevant database records identified by the manifest.

In step 680, based on the retrieved set of relevant database records, the computing system rebuilds the database in a primary storage (e.g., new primary storage bucket 122A in FIG. 4) of the cloud-based storage system. In various embodiments, the set of relevant database records includes 1) data records (e.g., data records 112A) including data of the database, log records (e.g., log records 112B) of a transaction log, and/or catalog records (e.g., catalog records 112C) defining schema of the database. In some embodiments, step 680 includes inserting the data records into a log structured merge (LSM) tree having one or more levels stored in the primary storage. In some embodiments, step 680 further includes replaying the transaction log to recover the database to the prior state. In some embodiments, step 680 further includes rebuilding a database catalog based on the defined schema.

### Exemplary Multi-Tenant Database System

Turning now to FIG. 7, an exemplary multi-tenant database system (MTS) 700, which may implement functionality of computing system 10, is depicted. In the illustrated embodiment, MTS 700 includes a database platform 710, an application platform 720, and a network interface 730 connected to a network 740. Database platform 710 includes a data storage 712 and a set of database servers 714A-N that interact with data storage 712, and application platform 720 includes a set of application servers 722A-N having respective environments 724. In the illustrated embodiment, MTS 700 is connected to various user systems 750A-N through network 740. In other embodiments, techniques of this disclosure are implemented in non-multi-tenant environments such as client/server environments, cloud computing environments, clustered computers, etc.

MTS 700, in various embodiments, is a set of computer systems that together provide various services to users (alternatively referred to as “tenants”) that interact with MTS 700. In some embodiments, MTS 700 implements a customer relationship management (CRM) system that provides mechanism for tenants (e.g., companies, government bodies, etc.) to manage their relationships and interactions with customers and potential customers. For example, MTS 700 might enable tenants to store customer contact information (e.g., a customer's website, email address, telephone number, and social media data), identify sales opportunities, record service issues, and manage marketing campaigns. Furthermore, MTS 700 may enable those tenants to identify how customers have been communicated with, what the customers have bought, when the customers last purchased items, and what the customers paid. To provide the services of a CRM system and/or other services, as shown, MTS 700 includes a database platform 710 and an application platform 720.

Database platform 710, in various embodiments, is a combination of hardware elements and software routines that implement database services for storing and managing data of MTS 700, including tenant data. As shown, database platform 710 includes data storage 712. Data storage 712, in various embodiments, includes a set of storage devices (e.g., solid state drives, hard disk drives, etc.) that are connected together on a network (e.g., a storage attached network (SAN)) and configured to redundantly store data to prevent data loss. In various embodiments, primary storage bucket 122A implements at least a portion of data storage 712. Data storage 712 may implement a single database, a distributed database, a collection of distributed databases, a database with redundant online or offline backups or other redundancies, etc. As part of implementing the database, data storage 712 may store one or more database records 112 having respective data payloads (e.g., values for fields of a database table) and metadata (e.g., a key value, timestamp, table identifier of the table associated with the record, tenant identifier of the tenant associated with the record, etc.).

In various embodiments, a database record 112 may correspond to a row of a table. A table generally contains one or more data categories that are logically arranged as columns or fields in a viewable schema. Accordingly, each record of a table may contain an instance of data for each category defined by the fields. For example, a database may include a table that describes a customer with fields for basic contact information such as name, address, phone number, fax number, etc. A record therefore for that table may include a value for each of the fields (e.g., a name for the name field) in the table. Another table might describe a purchase order, including fields for information such as customer, product, sale price, date, etc. In various embodiments, standard entity tables are provided for use by all tenants, such as tables for account, contact, lead and opportunity data, each containing pre-defined fields. MTS 700 may store, in the same table, database records for one or more tenants—that is, tenants may share a table. Accordingly, database records, in various embodiments, include a tenant identifier that indicates the owner of a database record. As a result, the data of one tenant is kept secure and separate from that of other tenants so that that one tenant does not have access to another tenant's data, unless such data is expressly shared.

In some embodiments, data storage 712 is organized as part of a log-structured merge-tree (LSM tree). As noted above, a database server 714 may initially write database records into a local in-memory buffer data structure before later flushing those records to the persistent storage (e.g., in data storage 712). As part of flushing database records, the database server 714 may write the database records 112 into new files/extents 210 that are included in a “top” level of the LSM tree. Over time, the database records may be rewritten by database servers 714 into new files included in lower levels as the database records are moved down the levels of the LSM tree. In various implementations, as database records age and are moved down the LSM tree, they are moved to slower and slower storage devices (e.g., from a solid-state drive to a hard disk drive) of data storage 712.

When a database server 714 wishes to access a database record for a particular key, the database server 714 may traverse the different levels of the LSM tree for files that potentially include a database record for that particular key 211. If the database server 714 determines that a file may include a relevant database record, the database server 714 may fetch the file from data storage 712 into a memory of the database server 714. The database server 714 may then check the fetched file for a database record 112 having the particular key 211. In various embodiments, database records 112 are immutable once written to data storage 712. Accordingly, if the database server 714 wishes to modify the value of a row of a table (which may be identified from the accessed database record), the database server 714 writes out a new database record 112 into the buffer data structure, which is purged to the top level of the LSM tree. Over time, that database record 112 is merged down the levels of the LSM tree. Accordingly, the LSM tree may store various database records 112 for a database key such that the older database records 112 for that key are located in lower levels of the LSM tree then newer database records.

Database servers 714, in various embodiments, are hardware elements, software routines, or a combination thereof capable of providing database services, such as data storage, data retrieval, and/or data manipulation. Accordingly, in some embodiments, database servers 714 execute DBMS 110 and/or archival agent 130 discussed above. Such database services may be provided by database servers 714 to components (e.g., application servers 722) within MTS 700 and to components external to MTS 700. As an example, a database server 714 may receive a database transaction request from an application server 722 that is requesting data to be written to or read from data storage 712. The database transaction request may specify an SQL SELECT command to select one or more rows from one or more database tables. The contents of a row may be defined in a database record and thus database server 714 may locate and return one or more database records that correspond to the selected one or more table rows. In various cases, the database transaction request may instruct database server 714 to write one or more database records for the LSM tree-database servers 714 maintain the LSM tree implemented on database platform 710. In some embodiments, database servers 714 implement a relational database management system (RDMS) or object-oriented database management system (OODBMS) that facilitates storage and retrieval of information against data storage 712. In various cases, database servers 714 may communicate with each other to facilitate the processing of transactions. For example, database server 714A may communicate with database server 714N to determine if database server 714N has written a database record into its in-memory buffer for a particular key.

Application platform 720, in various embodiments, is a combination of hardware elements and software routines that implement and execute CRM software applications as well as provide related data, code, forms, web pages and other information to and from user systems 750 and store related data, objects, web page content, and other tenant information via database platform 710. In order to facilitate these services, in various embodiments, application platform 720 communicates with database platform 710 to store, access, and manipulate data. Accordingly, in some embodiments, application platform 720 (or more specifically application servers 722) may correspond to clients 20 discussed above. In some instances, application platform 720 may communicate with database platform 710 via different network connections. For example, one application server 722 may be coupled via a local area network and another application server 722 may be coupled via a direct network link. Transfer Control Protocol and Internet Protocol (TCP/IP) are exemplary protocols for communicating between application platform 720 and database platform 710, however, it will be apparent to those skilled in the art that other transport protocols may be used depending on the network interconnect used.

Application servers 722, in various embodiments, are hardware elements, software routines, or a combination thereof capable of providing services of application platform 720, including processing requests received from tenants of MTS 700. Application servers 722, in various embodiments, can spawn environments 724 that are usable for various purposes, such as providing functionality for developers to develop, execute, and manage applications. Data may be transferred into an environment 724 from another environment 724 and/or from database platform 710. In some cases, environments 724 cannot access data from other environments 724 unless such data is expressly shared. In some embodiments, multiple environments 724 can be associated with a single tenant.

Application platform 720 may provide user systems 750 access to multiple, different hosted (standard and/or custom) applications, including a CRM application and/or applications developed by tenants. In various embodiments, application platform 720 may manage creation of the applications, testing of the applications, storage of the applications into database objects at data storage 712, execution of the applications in an environment 724 (e.g., a virtual machine of a process space), or any combination thereof. In some embodiments, application platform 720 may add and remove application servers 722 from a server pool at any time for any reason, there may be no server affinity for a user and/or organization to a specific application server 722. In some embodiments, an interface system (not shown) implementing a load balancing function (e.g., an F5 Big-IP load balancer) is located between the application servers 722 and the user systems 750 and is configured to distribute requests to the application servers 722. In some embodiments, the load balancer uses a least connections algorithm to route user requests to the application servers 722. Other examples of load balancing algorithms, such as are round robin and observed response time, also can be used. For example, in certain embodiments, three consecutive requests from the same user could hit three different servers 722, and three requests from different users could hit the same server 722.

In some embodiments, MTS 700 provides security mechanisms, such as encryption, to keep each tenant's data separate unless the data is shared. If more than one server 714 or 722 is used, they may be located in close proximity to one another (e.g., in a server farm located in a single building or campus), or they may be distributed at locations remote from one another (e.g., one or more servers 714 located in city A and one or more servers 722 located in city B). Accordingly, MTS 700 may include one or more logically and/or physically connected servers distributed locally or across one or more geographic locations.

One or more users (e.g., via user systems 750) may interact with MTS 700 via network 740. User system 750 may correspond to, for example, a tenant of MTS 700, a provider (e.g., an administrator) of MTS 700, or a third party. Each user system 750 may be a desktop personal computer, workstation, laptop, PDA, cell phone, or any Wireless Access Protocol (WAP) enabled device or any other computing device capable of interfacing directly or indirectly to the Internet or other network connection. User system 750 may include dedicated hardware configured to interface with MTS 700 over network 740. User system 750 may execute a graphical user interface (GUI) corresponding to MTS 700, an HTTP client (e.g., a browsing program, such as Microsoft's Internet Explorer™ browser, Netscape's Navigator™ browser, Opera's browser, or a WAP-enabled browser in the case of a cell phone, PDA or other wireless device, or the like), or both, allowing a user (e.g., subscriber of a CRM system) of user system 750 to access, process, and view information and pages available to it from MTS 700 over network 740. Each user system 750 may include one or more user interface devices, such as a keyboard, a mouse, touch screen, pen or the like, for interacting with a graphical user interface (GUI) provided by the browser on a display monitor screen, LCD display, etc. in conjunction with pages, forms and other information provided by MTS 700 or other systems or servers. As discussed above, disclosed embodiments are suitable for use with the Internet, which refers to a specific global internetwork of networks. It should be understood, however, that other networks may be used instead of the Internet, such as an intranet, an extranet, a virtual private network (VPN), a non-TCP/IP based network, any LAN or WAN or the like.

Because the users of user systems 750 may be users in differing capacities, the capacity of a particular user system 750 might be determined one or more permission levels associated with the current user. For example, when a salesperson is using a particular user system 750 to interact with MTS 700, that user system 750 may have capacities (e.g., user privileges) allotted to that salesperson. But when an administrator is using the same user system 750 to interact with MTS 700, the user system 750 may have capacities (e.g., administrative privileges) allotted to that administrator. In systems with a hierarchical role model, users at one permission level may have access to applications, data, and database information accessible by a lower permission level user, but may not have access to certain applications, database information, and data accessible by a user at a higher permission level. Thus, different users may have different capabilities with regard to accessing and modifying application and database information, depending on a user's security or permission level. There may also be some data structures managed by MTS 700 that are allocated at the tenant level while other data structures are managed at the user level.

In some embodiments, a user system 750 and its components are configurable using applications, such as a browser, that include computer code executable on one or more processing elements. Similarly, in some embodiments, MTS 700 (and additional instances of MTSs, where more than one is present) and their components are operator configurable using application(s) that include computer code executable on processing elements. Thus, various operations described herein may be performed by executing program instructions stored on a non-transitory computer-readable medium and executed by processing elements. The program instructions may be stored on a non-volatile medium such as a hard disk, or may be stored in any other volatile or non-volatile memory medium or device as is well known, such as a ROM or RAM, or provided on any media capable of staring program code, such as a compact disk (CD) medium, digital versatile disk (DVD) medium, a floppy disk, and the like. Additionally, the entire program code, or portions thereof, may be transmitted and downloaded from a software source, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the disclosed embodiments can be implemented in any programming language that can be executed on a server or server system such as, for example, in C, C+, HTML, Java, JavaScript, or any other scripting language, such as VBScript.

Network 740 may be a LAN (local area network), WAN (wide area network), wireless network, point-to-point network, star network, token ring network, hub network, or any other appropriate configuration. The global internetwork of networks, often referred to as the “Internet” with a capital “I,” is one example of a TCP/IP (Transfer Control Protocol and Internet Protocol) network. It should be understood, however, that the disclosed embodiments may utilize any of various other types of networks.

User systems 750 may communicate with MTS 700 using TCP/IP and, at a higher network level, use other common Internet protocols to communicate, such as HTTP, FTP, AFS, WAP, etc. For example, where HTTP is used, user system 750 might include an HTTP client commonly referred to as a “browser” for sending and receiving HTTP messages from an HTTP server at MTS 700. Such a server might be implemented as the sole network interface between MTS 700 and network 740, but other techniques might be used as well or instead. In some implementations, the interface between MTS 700 and network 740 includes load sharing functionality, such as round-robin HTTP request distributors to balance loads and distribute incoming HTTP requests evenly over a plurality of servers.

In various embodiments, user systems 750 communicate with application servers 722 to request and update system-level and tenant-level data from MTS 700 that may require one or more queries to data storage 712. In some embodiments, MTS 700 automatically generates one or more SQL statements (the SQL query) designed to access the desired information. In some cases, user systems 750 may generate requests having a specific format corresponding to at least a portion of MTS 700. As an example, user systems 750 may request to move data objects into a particular environment 724 using an object notation that describes an object relationship mapping (e.g., a JavaScript object notation mapping) of the specified plurality of objects.

The various techniques described herein and all disclosed or suggested variations, may be performed by one or more computer programs. The term “program” is to be construed broadly to cover a sequence of instructions in a programming language that a computing device can execute or interpret. These programs may be written in any suitable computer language, including lower-level languages such as assembly and higher-level languages such as Python.

Program instructions may be stored on a “non-transitory, computer-readable storage medium” or a “non-transitory, computer-readable medium.” The storage of program instructions on such media permits execution of the program instructions by a computer system. These are broad terms intended to cover any type of computer memory or storage device that is capable of storing program instructions. The term “non-transitory,” as is understood, refers to a tangible medium. Note that the program instructions may be stored on the medium in various formats (source code, compiled code, etc.).

The phrases “computer-readable storage medium” and “computer-readable medium” are intended to refer to both a storage medium within a computer system as well as a removable medium such as a CD-ROM, memory stick, or portable hard drive. The phrases cover any type of volatile memory within a computer system including DRAM, DDR RAM, SRAM, EDO RAM, Rambus RAM, etc., as well as non-volatile memory such as magnetic media, e.g., a hard drive, or optical storage. The phrases are explicitly intended to cover the memory of a server that facilitates downloading of program instructions, the memories within any intermediate computer system involved in the download, as well as the memories of all destination computing devices. Still further, the phrases are intended to cover combinations of different types of memories.

In addition, a computer-readable medium or storage medium may be located in a first set of one or more computer systems in which the programs are executed, as well as in a second set of one or more computer systems which connect to the first set over a network. In the latter instance, the second set of computer systems may provide program instructions to the first set of computer systems for execution. In short, the phrases “computer-readable storage medium” and “computer-readable medium” may include two or more media that may reside in different locations, e.g., in different computers that are connected over a network.

Note that in some cases, program instructions may be stored on a storage medium but not enabled to execute in a particular computing environment. For example, a particular computing environment (e.g., a first computer system) may have a parameter set that disables program instructions that are nonetheless resident on a storage medium of the first computer system. The recitation that these stored program instructions are “capable” of being executed is intended to account for and cover this possibility. Stated another way, program instructions stored on a computer-readable medium can be said to “executable” to perform certain functionality, whether or not current software configuration parameters permit such execution. Executability means that when and if the instructions are executed, they perform the functionality in question.

Similarly, systems that implement the methods described with respect to any of the disclosed techniques are also contemplated. One such environment in which the disclosed techniques may operate is a cloud computer system. A cloud computer system (or cloud computing system) refers to a computer system that provides on-demand availability of computer system resources without direct management by a user. These resources can include servers, storage, databases, networking, software, analytics, etc. Users typically pay only for those cloud services that are being used, which can, in many instances, lead to reduced operating costs. Various types of cloud service models are possible. The Software as a Service (SaaS) model provides users with a complete product that is run and managed by a cloud provider. The Platform as a Service (PaaS) model allows for deployment and management of applications, without users having to manage the underlying infrastructure. The Infrastructure as a Service (IaaS) model allows more flexibility by permitting users to control access to networking features, computers (virtual or dedicated hardware), and data storage space. Cloud computer systems can run applications in various computing zones that are isolated from one another. These zones can be within a single or multiple geographic regions.

A cloud computer system includes various hardware components along with software to manage those components and provide an interface to users. These hardware components include a processor subsystem, which can include multiple processor circuits, storage, and I/O circuitry, all connected via interconnect circuitry. Cloud computer systems thus can be thought of as server computer systems with associated storage that can perform various types of applications for users as well as provide supporting services (security, load balancing, user interface, etc.).

One common component of a cloud computing system is a data center. As is understood in the art, a data center is a physical computer facility that organizations use to house their critical applications and data. A data center's design is based on a network of computing and storage resources that enable the delivery of shared applications and data.

The term “data center” is intended to cover a wide range of implementations, including traditional on-premises physical servers to virtual networks that support applications and workloads across pools of physical infrastructure and into a multi-cloud environment. In current environments, data exists and is connected across multiple data centers, the edge, and public and private clouds. A data center can frequently communicate across these multiple sites, both on-premises and in the cloud. Even the public cloud is a collection of data centers. When applications are hosted in the cloud, they are using data center resources from the cloud provider. Data centers are commonly used to support a variety of enterprise applications and activities, including, email and file sharing, productivity applications, customer relationship management (CRM), enterprise resource planning (ERP) and databases, big data, artificial intelligence, machine learning, virtual desktops, communications and collaboration services.

Data centers commonly include routers, switches, firewalls, storage systems, servers, and application delivery controllers. Because these components frequently store and manage business-critical data and applications, data center security is critical in data center design. These components operate together provide the core infrastructure for a data center: network infrastructure, storage infrastructure and computing resources. The network infrastructure connects servers (physical and virtualized), data center services, storage, and external connectivity to end-user locations. Storage systems are used to store the data that is the fuel of the data center. In contrast, applications can be considered to be the engines of a data center. Computing resources include servers that provide the processing, memory, local storage, and network connectivity that drive applications. Data centers commonly utilize additional infrastructure to support the center's hardware and software. These include power subsystems, uninterruptible power supplies (UPS), ventilation, cooling systems, fire suppression, backup generators, and connections to external networks.

Data center services are typically deployed to protect the performance and integrity of the core data center components. Data center therefore commonly use network security appliances that provide firewall and intrusion protection capabilities to safeguard the data center. Data centers also maintain application performance by providing application resiliency and availability via automatic failover and load balancing.

One standard for data center design and data center infrastructure is ANSI/TIA-942. It includes standards for ANSI/TIA-942-ready certification, which ensures compliance with one of four categories of data center tiers rated for levels of redundancy and fault tolerance. A Tier 1 (basic) data center offers limited protection against physical events. It has single-capacity components and a single, nonredundant distribution path. A Tier 2 data center offers improved protection against physical events. It has redundant-capacity components and a single, nonredundant distribution path. A Tier 3 data center protects against virtually all physical events, providing redundant-capacity components and multiple independent distribution paths. Each component can be removed or replaced without disrupting services to end users. A Tier 4 data center provides the highest levels of fault tolerance and redundancy. Redundant-capacity components and multiple independent distribution paths enable concurrent maintainability and one fault anywhere in the installation without causing downtime.

Many types of data centers and service models are available. A data center classification depends on whether it is owned by one or many organizations, how it fits (if at all) into the topology of other data centers, the technologies used for computing and storage, and its energy efficiency. There are four main types of data centers. Enterprise data centers are built, owned, and operated by companies and are optimized for their end users. In many cases, they are housed on a corporate campus. Managed services data centers are managed by a third party (or a managed services provider) on behalf of a company. The company leases the equipment and infrastructure instead of buying it. In colocation (“colo”) data centers, a company rents space within a data center owned by others and located off company premises. The colocation data center hosts the infrastructure: building, cooling, bandwidth, security, etc., while the company provides and manages the components, including servers, storage, and firewalls. Cloud data centers are an off-premises form of data center in which data and applications are hosted by a cloud services provider such as AMAZON WEB SERVICES (AWS), MICROSOFT (AZURE), or IBM Cloud.

The present disclosure includes references to “an embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

1. A non-transitory computer readable medium having program instructions stored thereon that are capable of causing an archival agent of a database to implement operations comprising:
tracking database records stored in a primary storage of a cloud-based storage system to identify particular ones of the database records that are relevant to a current state of the database, wherein a replication service of the cloud-based storage system is operable to replicate database records from the primary storage to an archival storage that includes database records of the database that are no longer relevant to the current state of database;
recording identifiers of the particular relevant database records in a manifest file associated with the current state of the database;
providing the manifest file to the replication service for storage in the archival storage; and
in response to a failure associated with the primary storage, recovering the database to the current state using the identifiers recorded in the stored manifest file to determine what database records to read from the archival storage.

2. The computer readable medium of claim 1, wherein the operations further comprise:
prior to the recovering, performing a validation of the manifest file stored in the archival storage, wherein the validation includes:
reading the recorded identifiers from the manifest file; and
based on the read identifiers, verifying that the replication service successfully replicated the particular relevant database records to the archival storage.

3. The computer readable medium of claim 2, wherein the recovering includes:
selecting the stored manifest file from among a plurality of manifest files associated with states of the database; and
confirming that the manifest file has been successfully validated.

4. The computer readable medium of claim 2, wherein the operations further comprise:
prior to the manifest file being successfully validated, barring a garbage collector from reclaiming storage space occupied by database records in the primary storage that have identifiers recorded in the manifest file.

5. The computer readable medium of claim 1, wherein the operations further comprise:
performing a garbage collection to reclaim storage space in the archival storage, wherein the garbage collection includes:
determining that the archival storage includes a particular manifest file that has been stored for a length of time that exceeds a time threshold;
identifying recorded identifiers in the particular manifest file that are not present in any other manifest files stored in the archival storage; and
reclaiming storage space occupied by database records associated with the identified recorded identifiers.

6. The computer readable medium of claim 1, wherein the recorded identifiers are unique identifiers of files that includes sets of multiple database records.

7. The computer readable medium of claim 1, wherein the recovering includes:
based on the identifiers recorded in the stored manifest file, reading data records and log records from the archival storage;
recovering the database to an initial state based on the data records; and
transitioning the recovered database from the initial state to the current state by replaying a transaction log defined in the log records.

8. The computer readable medium of claim 1, wherein the primary storage and the archival storage are object storages;
wherein the recorded identifiers are keys for retrieving the particular relevant database records from the primary storage and the archival storage; and
wherein providing the manifest file to the replication service for storage includes:
writing the manifest file to the primary storage to cause the replication service to replicate the manifest file to the archival storage.

9. A method performed by a computing system to archive database records using an archival storage of a cloud-based storage system, comprising:
tracking database records that are relevant to a current state of a database that implements a copy-on-write storage scheme for storing database records in a primary storage;
recording, in a manifest for recovering the database, identifiers of the relevant database records and a timestamp associated with the current state of the database; and
providing the manifest to a replication service of the cloud-based storage for storage in the archival storage, wherein the replication service replicates database records from the primary storage to the archival storage; and
in response to a failure associated with the primary storage, recovering the database to the current state using the identifiers recorded in the stored manifest file to determine what database records to read from the archival storage.

10. The method of claim 9, further comprising:
prior to permitting a recovery using the manifest:
determining whether the replication service has successfully replicated the relevant database records to the archival storage; and
based on the determining, storing, in the archival storage, an indication that the manifest is valid.

11. The method of claim 9, further comprising:
in response to the manifest being stored in the archival storage for a length of time that satisfies a time threshold:
determining the recorded identifiers in the manifest; and
garbage collecting the relevant database records identified by the determined identifiers unless the identifiers are included in any other manifests stored in the archive storage.

12. The method of claim 9, wherein the relevant database records include 1) data records that include data, 2) log records including log metadata of a transaction log, and 3) catalog records including schema metadata defining a catalog of the database.

13. The method of claim 9, wherein the primary storage and the archival storage are key-value storages; and
wherein the recorded identifiers are keys usable to retrieve the relevant database records from the primary storage and the archival storage.

14. The method of claim 13, wherein a given one of the keys uniquely identifies a container that includes multiple ones of the relevant database records.

15. The method of claim 9, wherein the database organizes database records in the primary storage using a log structured merge (LSM) tree.

16. A non-transitory computer readable medium having program instructions stored thereon that are capable of causing a computing system recovering a database to perform operations comprising:
receiving a request to recover a database to a prior state of the database, wherein the request identifies a timestamp associated with the prior state;
based on the timestamp, selecting one of a plurality of manifests stored in an archival storage of a cloud-based storage system, wherein the manifest identifies a set of database records relevant to a current state of the database when the manifest was created;
issuing, to the archival storage, a request to retrieve the set of relevant database records identified by the manifest; and
based on the retrieved set of relevant database records, rebuilding the database in a primary storage of the cloud-based storage system.

17. The computer readable medium of claim 16, wherein the selecting includes:
determining that the manifest has been identified as valid based on a previous validation of the manifest.

18. The computer readable medium of claim 16, wherein the set of relevant database records includes data records including data of the database; and
wherein the rebuilding includes inserting the data records into a log structured merge (LSM) tree having one or more levels stored in the primary storage.

19. The computer readable medium of claim 16, wherein the set of relevant database records includes log records of a transaction log; and
wherein the rebuilding includes replaying the transaction log to recover the database to the prior state.

20. The computer readable medium of claim 16, wherein the set of relevant database records includes catalog records defining schema of the database; and
wherein the rebuilding includes rebuilding a database catalog based on the defined schema.
